(19) United States
(12) Patent Application Publication
(10) Pub. No.: US 2005/0173035 A1
(43) Pub. Date: Aug. 11, 2005

(54) Elongated block tire tread

(76) Inventor: Richard Heinen, Habay-Ia-Neuve (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/775,795

(22) Filed: Feb. 10, 2004

(51) Int. Cl. B60C 11/13; B60C 111/00; B60C 17/00; B60C 115/00; B60C 11/03

(52) U.S. Cl. 152/209.9; 152/209.8; 152/209.15; 152/209.18; 152/209.24; 152/209.28

(57) ABSTRACT

A tire tread has two circumferential grooves and a circumferentially extending column of tetragon shaped blocks located between the two circumferential grooves. In the circumferential extending column of blocks, each block is separated from an adjacent block by an inclined lateral groove, the inclined lateral groove forming an angle between 10° to 25° with one of the circumferential grooves. Each block in the column has a circumferential length L greater than the normal pressure footprint length F_{L} of the tire. The length of the blocks permits the column of adjacent blocks to act as a rib while maintaining desired block characteristics.

### FIELD OF THE INVENTION

The present invention is directed to a tire tread. More specifically, the invention is directed to a tire tread comprising at least one column of long blocks, the blocks shaped to work like a circumferential rib in regards to noise, durability, and handling, but acting like a block for aquaplaning and wet drive performances

### BACKGROUND OF THE INVENTION

The features of tire treads are generally divided into two categories: ribs and blocks.

A rib is a continuously extending tread element that encircles the entire tire tread circumference. The rib may be provided with limited grooving, but any such provided grooves will not complete bisect the rib. Ribs are known for providing less noise as there are fewer tread edges and lateral grooves entering and exiting the footprint. The fewer number of tread edges of a rib also provides for improved wear and the solid nature of the rib provides for better handling and stability of the tread.

A block is a discrete tread element and may be arranged to extend in either a circumferential or lateral direction of the tread. Blocks are defined by grooves that extend in opposing directions. Due to the increased number of grooves to form the blocks, as opposed to the ribs, the water flow characteristics of a block tread generally tend to be greater than for a rib tread. The greater number of edges also provides for greater traction.

The use of a ribs or blocks in a tread may be dictated by the end use of the tire. Ribs are often selected for use on truck tire treads to provide durability, handling, and noise characteristics. Blocks are selected for use on passenger tires to provide traction and wet drive performance. In designing a tire tread, a tread designer might also combine rib and block elements to optimize the tire tread performance. For example, a rib at the centerline of a tire provides for a quieter ride since the centerline of the tire is always in the contact patch, while blocks on both sides of the centerline rib assist in water evacuation and traction.

### SUMMARY OF THE INVENTION

The present invention is directed to a tread element that combines the characteristics of both a rib and a block tread element. Disclosed is a pneumatic tire having a tread. The tread has two circumferential grooves and a circumferentially extending column of tetragon shaped blocks located between the two circumferential grooves. In the circumferential extending column of blocks, each block is separated from an adjacent block by an inclined lateral groove, the inclined lateral groove forming an angle between 10° to 25° with one of the circumferential grooves. Furthermore, each block in the column has a circumferential length L at least equal to the normal pressure footprint length L_{F} of the tire. The length of the blocks permits the column of adjacent blocks to act as a rib while maintaining desired block characteristics. Preferably, the blocks have a length L in the range of 100-400% of the normal pressure footprint length L_{F} of the tire.

In one disclosed aspect, for any straight line drawn in the lateral direction of the tread, the straight line passes through at least two circumferentially adjacent blocks in the circumferentially extending column of blocks. Preferably, the straight line passes through at least three blocks in the circumferentially extending column of blocks.

The column of the extended length blocks may be located in any position on the tread. The column may be located in just one tread half, it may be on the tread centerplane, or it may be bounded by the tread centerplane. Alternatively, the tread may have two columns of extended length blocks. For such a tire tread, the lateral grooves in each block column may be inclined in opposing directions, creating a directional tire.

In another disclosed aspect of the invention, each block has a pair of opposing sides forming a wall of the circumferential grooves. The pair of sides are circumferentially spaced by a distance f in the range of 20% to 60% of the circumferential length L of the block. Additionally, at least one of these sides may be inclined at angle greater than 0° relative to the tread centerline.

In another aspect, the inclined lateral grooves have a width less than the width of the circumferential grooves.

In another aspect, the blocks have a width W_{B}, measured perpendicular to the longest sides of the blocks, in the range of 15% to 65% the distance between the circumferential grooves.

In another aspect, to reduce premature wear, at least one of the acute angled corners of each block may be chamfered.

In another aspect, to strength the block, the sides of the blocks forming a wall of the circumferential grooves may have the radially outer portion thereof inclined at an angle, relative to the radial direction of the tire, greater than the inclination angle of the radially inner portion of the wall. Preferably, the radially outer portion of the groove wall is inclined at least 10° greater than the radially inner portion of the groove wall.

### BRIEF DESCRIPTION OF THE DRAWINGS

The invention will be described by way of example and with reference to the accompanying drawings in which:

FIG. 1 is a tire tread in accordance with the present invention;

FIG. 2 is an alternative tread configuration;

FIG. 3 is a footprint of a tire in accordance with the present invention;

FIG. 4 is a view of the tread along line 4-4 in FIG. 1;

FIG. 5 is a view of the tread along line 5-5 in FIG. 1;

FIGS. 6-7 are alternative tread configurations.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

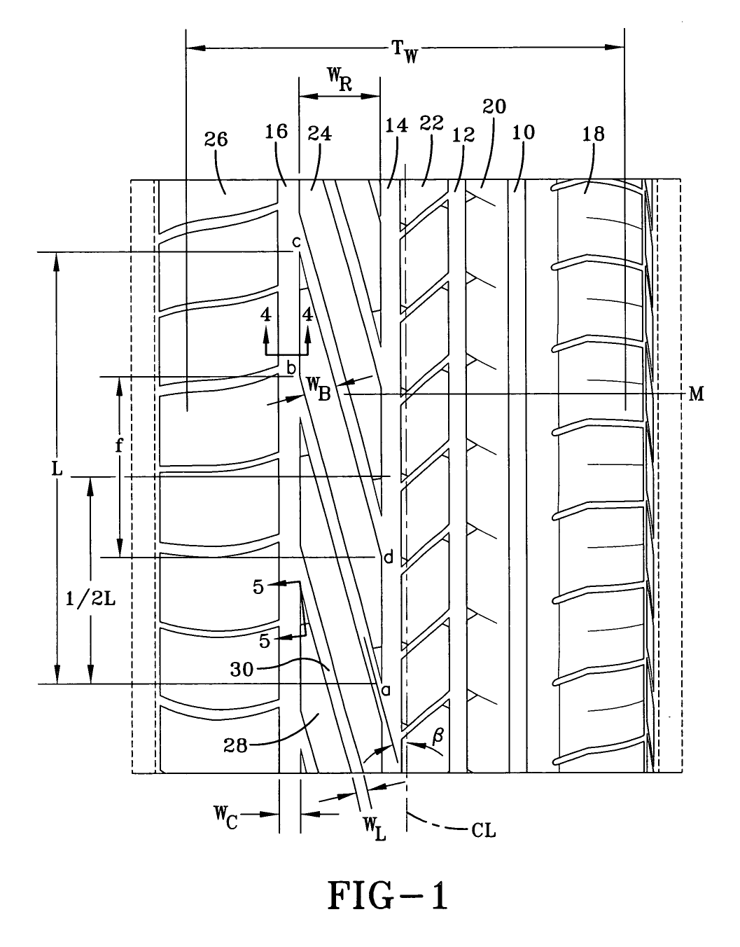

FIG. 1 illustrates a tire tread for a pneumatic tire. The instant tread has an asymmetrical configuration formed in part by circumferential grooves 10, 12, 14, 16. In the instant tread configuration, the circumferential grooves 10, 12, 14, 16 partially form two ribs 18, 20 and three block columns 22, 24, 26. The tire tread has a centerline CL and when employed on a pneumatic tire and inflated to a normal inflation pressure, forms a footprint FP on the surface the tire contacts.

The principal feature of interest in the tread is the middle block column 24. The individual blocks 28 in the column 24 are formed by the pair of adjacent circumferential grooves 14, 16 and lateral grooves 30 extending between the circumferential grooves 14, 16. The blocks 28 have an extended tetragon shape, defined by sides a-b, b-c, c-d, d-a, with the longest sides a-b, c-d of the tetragon bounded by the lateral grooves 30. The short sides b-c, d-a of the blocks 28 are formed by the circumferential grooves 14, 16. For the illustrated blocks 28, the tetragon shape is a parallelogram.

The blocks 28 have a circumferential length L, measured parallel to the tread centerline CL and from the farthest points a, c of the block 28. The opposing short sides b-c, d-a are circumferentially spaced from each other along the tread length by a distance f. The spacing distance f is 20 to 60% of the circumferential block length L. Preferably, the spacing distance f is 40 to 50% of the circumferential block length L. The spacing distance f will increase with an increased tire diameter and decrease with a decreased tire diameter. The spacing distance f will partially dictate the block length L relative to the tire circumference.

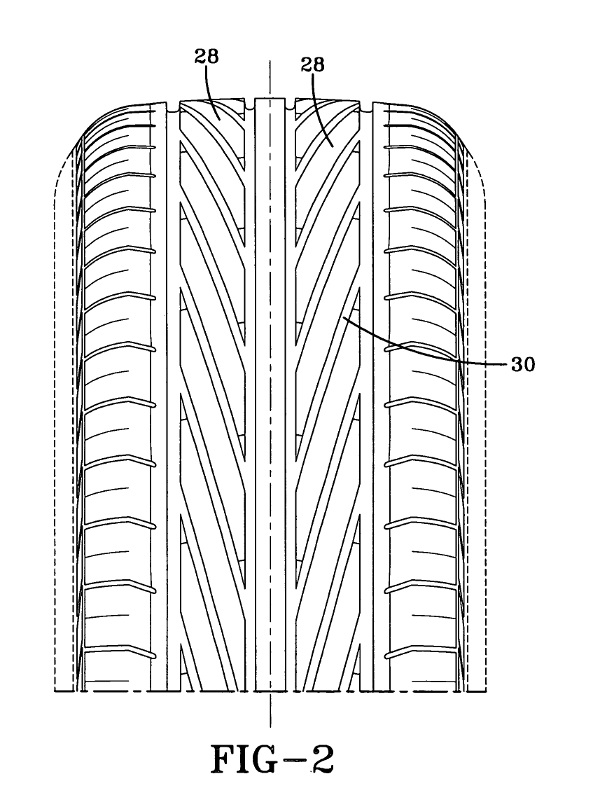

The lateral grooves 30 partially forming the blocks 28 are inclined at a minimum angle β of 10° relative to either circumferential groove or the tread centerline CL. The lateral grooves 30 have a maximum angle β of 25° relative to the circumferential grooves. The lateral grooves 30 may be inclined in either direction, relative to the tread centerline CL, see also FIG. 2, wherein the tread is a directional tread with two columns of the extended length blocks 28, one column in each half of the tread. The lateral grooves 30 have a width W_{L} less than the width W_{C} of the circumferential grooves. The width W_{L} may vary depending on the inclination angle β and the number or circumferential length L of the blocks 28 along the circumference of the tire tread.

The number of extended length blocks 28 in the tire circumference depends on the inclination angle β of the lateral grooves 30, the lateral groove width WL and the block width W_{B}. The block width W_{B} is measured perpendicular to the two longest sides a-b, c-d, of the blocks 28. The block width W_{B} ranges from 15% to 65% of the column width W_{R}. The column width W_{R} is independent of the number of blocks 28 or the lateral groove inclination angle β, and is 15% to 50% of the tread width TW. For larger sized tires, such as a 315/35R20, the column width W_{R} may be closer to the maximum preferred width of 50% of the tread width TW.

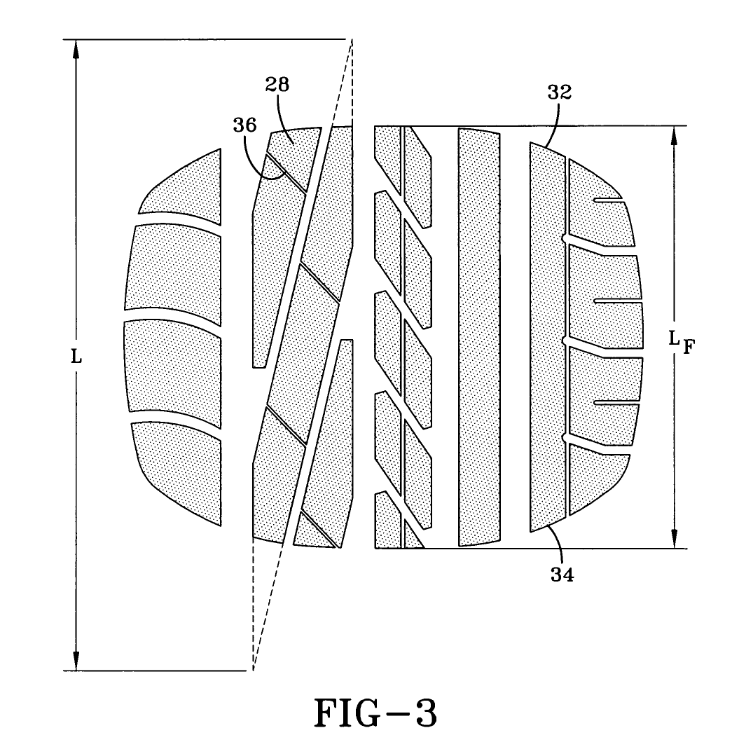

To enable the block column 24 to achieve rib-like characteristics, the circumferential length L of each block 28 is at least equal to the footprint length L_{F}, see FIG. 3. FIG. 3 is a footprint of the tire of the FIG. 1, with the non-contact portion of the blocks 28 shown in dotted line. For the illustrated footprint, the block length L is approximately 150% the footprint length L_{F}. The footprint was from a tire size 245/45R18, inflated to 2.2 bar (31.9 psi, 2.24 kgf/cm²), and loaded at 630 kg. As can be appreciated by those skilled in the art, when the load on a tire is decreased, the area of the tire footprint decreases. Thus, at a lower load, the ratio between the block length L and the footprint length L_{F} increases. The footprint length L_{F}, is measured at zero speed, inflated to the manufacturer's recommend tire pressure (called the “normal pressure”) and subjected to the design load. The footprint length L_{F} is measured from the maximum point on the first line 32 of the footprint to the maximum point on the opposing line 34 of the footprint. For the footprint of FIG. 3, the maximum points occur at the footprint centerline; however, for a butterfly shaped footprint, the maximum points will occur towards the lateral edges of the footprint. Depending on the block length L selected for a particular tire tread configuration, the block length L is at least 100% of the footprint length L_{F}, and is preferably, 100 to 400% of the footprint length L_{F}, and more preferably, 100% to 300% of the footprint length L_{F}.

Because of the long length of the blocks 28, to provide for flexibility in the tread, the blocks 28 may be provided with decoupling grooves 36. The decoupling grooves 36 have a width substantially less than the lateral groove width W_{L}, but slightly greater than a conventional sipe width that closes upon contact with the ground. The decoupling grooves 36 do not significantly affect the water flow characteristics of the tread, and do not prevent the blocks 28 from achieving the desired rib-like characteristics.

Part of the goal of the extended length blocks 28 is for the blocks 28 to mimic the action of a tread rib element while retaining block element features. Important features of blocks are water evacuation and traction edges. To assist in achieving these features, in the tire footprint FL there are at least three overlapped blocks 28. At any point along the circumferential block length L, a line M drawn in the lateral direction of the tread will pass through at least two adjacent blocks 28 in the column. Additionally, a lateral line M drawn in at least one location along the length L of the block 28 will pass through at least three blocks 28 in the single column 24. Preferably, at the mid length ½L of any block 28, a lateral line M will pass through at least three circumferential adjacent blocks 28 in the column 24.

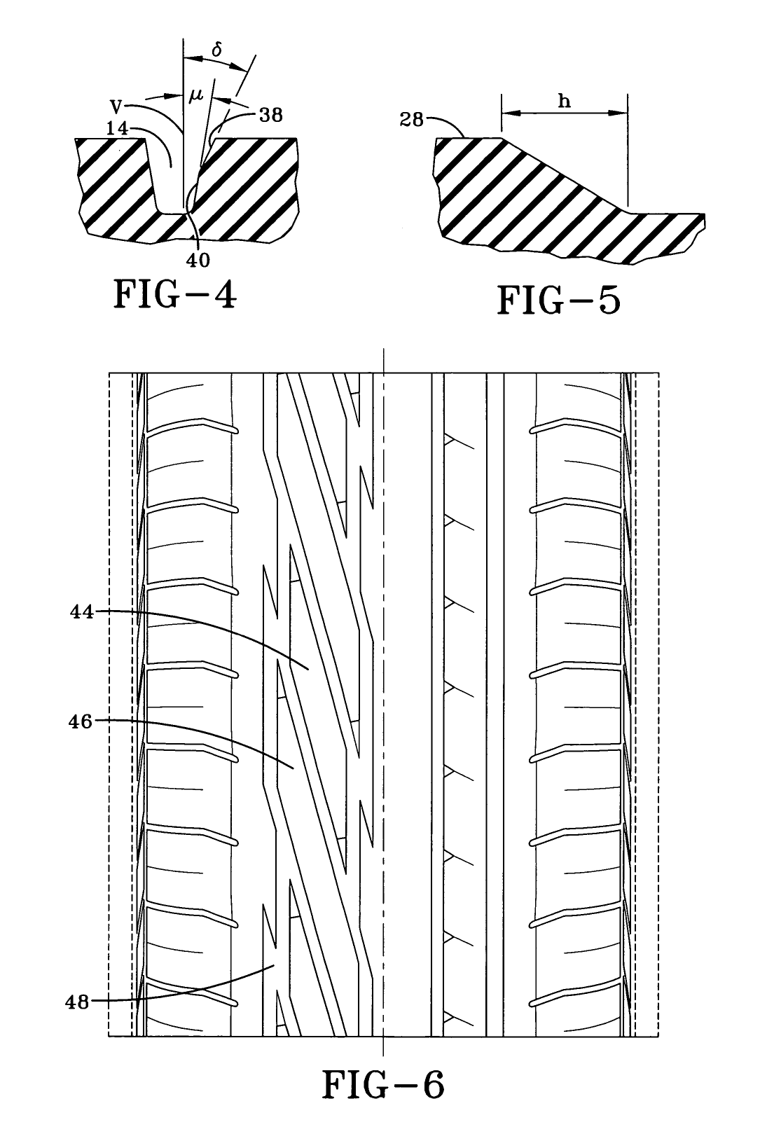

The circumferential sides b-c, d-a of the blocks 28 may be formed with dual angles to create a more open circumferential groove 14, or 16, see FIG. 4. The radially outer portion 38 of the block side, or groove wall, forms a larger angle δ relative to the vertical plane V than the angle μ, relative to the vertical plane V, formed by the radially inner portion 40 of the block side. The difference between the upper angle δ and the lower angle μ is at least 10°.

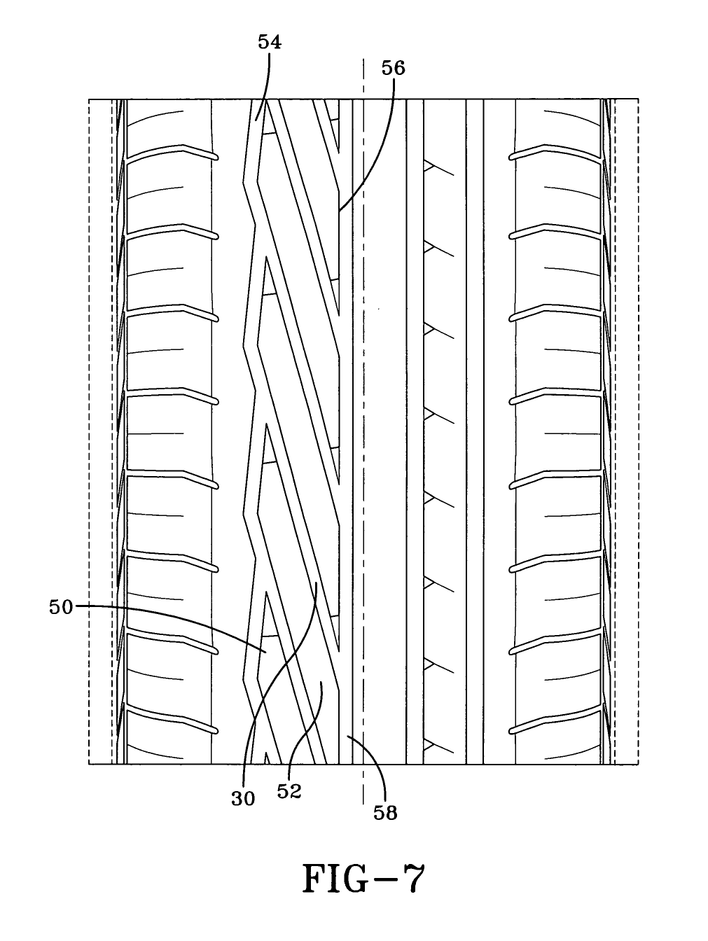

Another permissible variation in the tread blocks 28 is shown in FIG. 5. The acute angled corners a, c of the blocks 28 may be chamfered 42. When not chamfered, the acute angled corners a, c form a very sharp, very narrow tread point. Upon entering and exiting the tire contact patch as the tire rotates, this very narrow tread point is subjected to premature wear and chipping. By form a chamfer 42 at the corners a, c, premature wear and chipping is reduced. For at least a minimal reduction in premature wear, if the tire is a unidirectional tread, only the corner a or c which enters the tire contact patch first during normal forward rotation of the tire may be chamfered. The chamfer length, h, is in the range of 10-50% of the length of circumferential block side b-c, d-a.

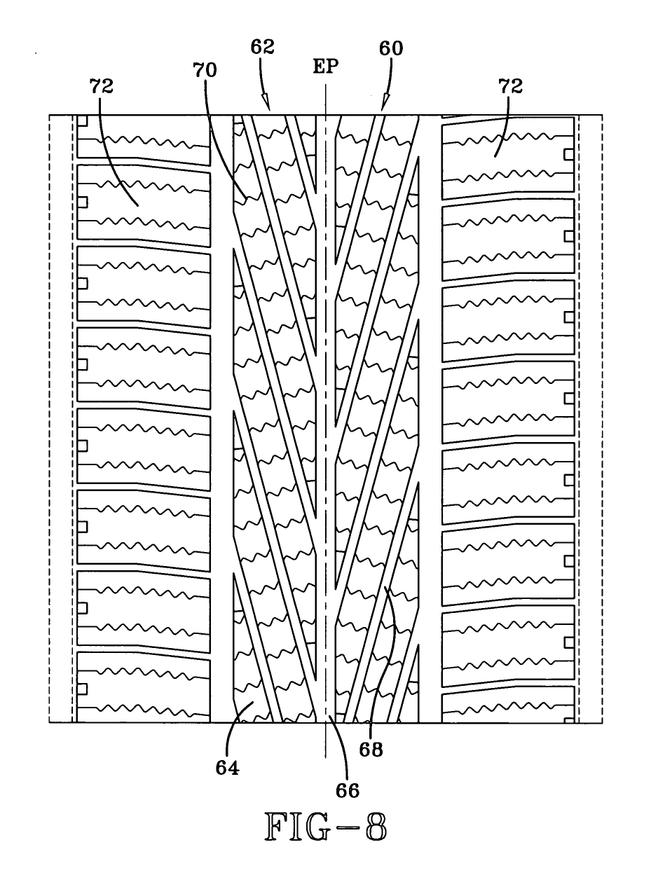

FIGS. 6 and 7 show additional alternatives for the block configurations in a tire tread.

In the tread of FIG. 6, alternating extended length blocks 44, 46 have different lateral lengths and axial widths. Blocks 44 have a lateral length and an axial width less than the lateral length and axial width of blocks 46. In maintaining a constant circumferential groove width WC, the circumferential grooves 48 bordering the column of blocks 44, 46 have a resulting zigzag configuration. Similar to the leading narrow points of the blocks 44, 46, any similar edges to the adjacent block or rib columns may also be chamfered to reduce preliminary wear.

In the tread of FIG. 7, one short side 50 of the tetragon shaped blocks 52 is inclined relative to the tread centerline CL at angle greater than 0°. The inclination angle of the short side 50 is preferably not greater than the inclination angle β of the lateral grooves 30. The circumferential groove 54 partially formed by the short side 50 has a zigzag configuration. The opposing short side 56 of the blocks 52 may also be similarly inclined; resulting in a similar configuration for both circumferential grooves 54, 58. When so inclined, either short side 50 or 56 may be inclined axially inward toward the center of the blocks 52, as illustrated for side 50, or away from the center of the blocks 52.

FIG. 8 is another tread variation, suitable for a winter tire tread, is illustrated. The tread is similar to that of FIG. 2, being comprised of two columns 60, 62 of long blocks 64. A circumferential groove 66 on the equatorial plane EP of the tread is common to both columns 60, 62. The lateral grooves 68 in each column 60, 62 are inclined in opposing directions relative to the equatorial plane EP of the tread. Additionally, the sides of the blocks 64 in each column 60, 62 partially forming the common circumferential groove 66 are circumferentially offset from the block sides in the adjacent column 62, 60. The long blocks 64 are formed with multiple sipes 70 to provide additional biting surfaces in the blocks. The tread edge blocks 72 are also provided with sipes 70.

Other variations in the tread are permissible. Most notably, the remaining tread features may be any combination of ribs and/or blocks, and the present invention is not limited to the exact treads illustrated herein. The circumferential grooves partially forming the extended length blocks may straddle the tread centerline to approximate a center rib. One of the circumferential grooves may itself be located on the tread centerline. Additionally, the lateral grooves are not required to be straight as illustrated. Any of a variety of features may be added or changed so long as the extended length shape of the blocks is maintained, permitting the block column to act like a rib to achieve rib-like characteristics for noise, durability, and handling performance.

1. A pneumatic tire, the tire comprising a tread, the tread comprising two circumferential grooves and a circumferentially extending column of tetragon shaped blocks located between the two circumferential grooves,
in the circumferential extending column of blocks, each block is separated from an adjacent block by an inclined lateral groove, the inclined lateral groove forming an angle between 10° to 25° with one of the circumferential grooves,
the tread being characterized by each block in the column having a circumferential length L at least equal to the normal pressure footprint length L_{F} of the tire.

2. The tire of claim 1 wherein for any straight line drawn in the lateral direction of the tread, the straight line passes through at least two circumferentially adjacent blocks in the circumferentially extending column of blocks.

3. The tire of claim 1 wherein for any straight line drawn in the lateral direction of the tread, the straight line passes through at least three blocks in the circumferentially extending column of blocks.

4. The tire of claim 1 wherein a straight line drawn in the lateral direction of the tire at the mid-length, ½ L, of the block passes through at least three blocks in the circumferentially extending column of blocks.

5. The tire of claim 1 wherein the axial distance between the two circumferential grooves being in the range of 15 to 50% of the tread width.

6. The tire of claim 1 wherein tread is divided at a tread centerline into two tread halves and the two circumferential grooves are located in one tread half.

7. The tire of claim 6 wherein one of the two circumferential grooves is located on the tread centerline.

8. The tire of claim 1 wherein the tread is further comprised of a second circumferentially extending column of parallelogram shaped blocks located between a pair of circumferential grooves, the blocks in the second column being separated by inclined lateral grooves, the inclined lateral grooves in the first column and the inclined lateral grooves in the second column being inclined in opposing directions relative to a tread centerline.

9. The tire of claim 8 wherein the tread is divided at the tread centerline into two tread halves and one of the columns of blocks is located in each tread half.

10. The tire of claim 1 wherein the circumferentially extending column of blocks is axially centered on the equatorial plane of the tire.

11. The tire of claim 1 wherein each block has a pair of opposing sides forming a wall of the circumferential grooves, the pair of sides being circumferentially spaced by a distance d in the range of 20% to 60% of the circumferential length L of the block.

12. The tire of claim 1 wherein each block has a pair of acute angled corners, at least one of the acute angled corners being chamfered.

13. The tire of claim 1 wherein the circumferential grooves have a pair of opposing groove walls, one of the groove walls forming one side of the parallelogram shaped blocks and having a radially outer portion inclined at a greater angle relative to the radial direction of the tire than the radially inner portion of the groove wall.

14. The tire of claim 13 wherein the radially outer portion of the groove wall is inclined at least 10° greater than the radially inner portion of the groove wall.

15. The tire of claim 1 wherein the inclined lateral grooves have a width less than the width of the circumferential grooves.

16. The tire of claim 1 wherein the blocks have a width W_{B}, measured perpendicular to the longest sides of the blocks, in the range of 15% to 65% the distance between the circumferential grooves.

17. The tire of claim 1 wherein alternating blocks in the circumferentially extending column have different axial widths.

18. The tire of claim 1 wherein alternating blocks in the circumferentially extending columns have different circumferential lengths.

19. The tire of claim 1 wherein the tetragon shaped blocks have sides partially forming the two circumferential grooves, and at least one of the sides is inclined at an angle greater than 0° relative to a tread centerline.

20. The tire of claim 1 wherein each block in the columns has a circumferential length of 100-400% of the normal pressure footprint length L_{F} of the tire.
